(19) United States
(12) Patent Application Publication
(10) Pub. No.: US 2014/0196947 A1
(43) Pub. Date: Jul. 17, 2014

(54) GLAZING

(71) Applicant: Michael Lyon, Ormskirk (GB)

(72) Inventor: Michael Lyon, Ormskirk (GB)

(73) Assignee: Pikington Group Limited, N. Ormskirk, Lancashire (GB)

(21) Appl. No.: 14/237,253

(22) PCT Filed: Aug. 15, 2012
(86) PCT No.: PCT/GB2012/051988

§ 371 Date: Feb. 5, 2014

(30) Foreign Application Priority Data
Aug. 16, 2011 (GB) 1114076.1

(51) Int. Cl. H01R 4/02

(52) U.S. Cl. CPC H01R 4/023
USPC 174/75 R

(57) ABSTRACT

A glazing is provided comprising at least one ply of glass having an electrically conductive component connected to an electrical connector by a soldered joint. The solder has a composition comprising tin and silver, preferably 98Sn2Ag. The solder is lead-free. The connector is nickel plated and comprises copper, preferably 99 to 99.99 wt % Cu. Samples according to the present invention did not develop cracks in the glass during temperature cycling testing.

The present invention relates to glazings and more particularly glazings comprising soldered electrical connections between electrically conductive components on surfaces of the glazings and electrical connectors.

Glazings, especially vehicle glazings, may have electrically conductive components, such as circuits printed on the surface of a ply of glass or an array of wires fixed within a laminated glazing, in electrical connection to the wiring harness of a building or, more usually, a vehicle. Such circuits find use as heating circuits, to promote de-misting or de-icing, or as antenna circuits. Generally, electrical connection is made by a connector being soldered to an electrically conductive substrate known as a bus bar, which may be provided directly on the surface of a piece of glass, or fully or partly on a fired, printed band on the glass, known as an obscuration band. The bus bar is typically printed using a silver-containing ink. Historically, the solder used to join the bus bar and the connector contained lead. However, lead is known to be harmful, and there is increasing legislative pressure to use lead-free solders in industry.

Lead-free solders have been disclosed in, for example, WO-A-20 2004/068643 which relates to tin-based solders (up to 90% by weight tin) comprising a mechanical stress modifier selected from bismuth, indium or antimony. The solder may also contain silver and/or copper.

EP-2 177 305 discloses a lead-free solder alloy which can be used for soldering vehicle mounted electronic circuits, the alloy consists essentially of silver, indium (at 3 to 5.5 mass %), copper, optionally bismuth with the balance being tin.

WO-A-2007/110612 discloses some improved electrical connectors for use with glazings. The structure of the connector is chosen to maximise the adhesion between the electrically conductive components in the glazing and is especially for use with lead-free solders.

WO-A-2007/021326 discloses a solder composition having a mixture of elements including tin, indium, silver and bismuth and which includes between 30 to 85% tin and about 15 to 65% indium.

Unfortunately a number of lead-free solders can introduce problems when used, in particular, in vehicle glazings because such solders are not generally intended for use on glazings and so are not tested by accelerated aging for extended periods nor by extensive chemical testing using aggressive chemicals. More particularly, thermal cycling tests can result in glass breakage. Indium containing solders have been used to attempt to overcome the crack problem but they do have other problems related to their low melting point.

It is an aim of the present invention to address the problems of the prior art and to improve the suitability of Sn/Ag solders for use on automotive glass products, in particular to enable the use of Pb free solder (other than indium containing Pb free solders) and address the problem of cracks in Sn/Ag solders that are usually seen in thermal cycle tests.

The present invention accordingly provides in a first aspect a glazing comprising at least one ply of glass having an electrically conductive component on at least one surface, and an electrical connector electrically connected to the electrically conductive component through a soldered joint, the solder of the joint having a composition comprising tin and silver, wherein the electrical connector comprises a nickel plated contact for contacting the solder.

Surprisingly, a nickel plated contact appears to reduce glass breakage upon thermal cycling. This is greatly advantageous because of an increase in yield and the very extensive testing that electrical connections on vehicle glazings have to undergo to be accepted by vehicle manufacturers as well as the very high durability required in practice.

Preferably, the solder has a composition comprising 0.45 wt % or less indium. This is greatly advantageous because indium is expensive and contributes to a melting point of the solder which is too low.

Preferably, the solder comprises less than 0.5 wt % copper, more preferably less than 0.2 wt % Cu, most preferably less than 0.1 wt % Cu. It is most preferred that there is no deliberate addition of Cu to the solder.

It is preferred that the solder has a composition comprising less than 0.1 wt % Pb (i.e. is “Pb-free”). It is preferred that there is no deliberate addition of Pb to the solder.

Solders according to the invention may comprise 0.1 wt % or 0.5 wt % or more silver, more preferably 0.5 wt % to 10 wt % silver, 0.5 wt % to 5 wt % silver, and most preferably 0.8 to 2.5 wt % silver.

Preferably, the solder has a composition comprising:

90 to 99.5 wt % Sn, and

1 to 10 wt % Ag.

The most preferred solder composition is 95-99 wt % Sn and 1-5 wt % Ag.

In glazings according to the present invention, it is preferred if the electrically conductive component comprises electrically conductive silver-containing ink. The conductive component will usually be a component which is printed using such silver containing ink onto the surface of at least one ply of glass.

The connector comprises copper, preferably 99 to 99.99 wt % Cu.

The present invention is illustrated by the following description of preferred embodiments of the invention.

Indium has been identified as a critical raw material and therefore its long term availability is not something that can be guaranteed and the industry can not rely on it to replace Pb in solders.

When used with standard commercially available connectors used on automotive glass products indium solders form harmful intermetallics which result in cracks in the soldered joint. The intermetallics are present immediately after soldering and grow in size with time.

This is accelerated by high temperature but occurs more slowly at lower temperatures. The soldered connection is unstable.

Indium solders corrode more in humidity tests and salt spray exposure—both of which are required by the vehicle manufacturers.

The search for suitable Pb free solders for automotive glass products has been on-going for at least 10 years and many variants have been tested. Alternative materials to indium based solders are Tin (Sn) based and Bismuth (Bi) based. To assess the suitability of these types of solders two of the better materials were tested against the German Vehicle Manufacturers test specification. The results are shown in the table below.

TABLE 1

| | | Bi | Sn | Pb |
|---|---|---|---|---|
| Test Description | Specification | Solder | Solder | Solder |
| Temperature cycling | −40 C. to 105 C., Humidity not controlled | Fail | Fail | Pass |
| test according to DIN | (dry), Electrical current loading with 14 V | | | |
| EN ISO 16750-4-H | (+/−0.2) starting at end of low | | | |
| section 5.3.1.2 | temperature phase - 60 cycles (20 days) | | | |
| Heat soak test | Glass at 105° C. Electrical current loading | Pass | Pass | Pass |
| according to DIN EN | with 14 V (+/−0.2) throughout the test. | | | |
| ISO 16750-4-K section | 6 N mechanical load to soldering joints | | | |
| 5.1.2.2 | during heat storage. 96 hours | | | |
| High temperature | Temperature: 120° C.; No mechanical load | Pass | Pass | Pass |
| storage test | and no electrical load during the test. 24 | | | |
| | hours. | | | |
| Long term test without | Glass at 105° C., Electrical current loading | Pass | Pass | Pass |
| mechanical load | with 14 V (+/−0.2) throughout the test, | | | |
| | no mechanical load on connector. 500 | | | |
| | hours | | | |
| Heat shock test (water | Heat glass to 105° C. and keep at this | Not | Not | Not |
| splash) according to | temperature for 1 hour. Remove from oven | tested | tested | tested |
| DIN EN ISO 16750-4-H. | and within 20 seconds pour 3 litres of | | | |
| Splash water | water at 23 +/− 5° C. onto outside face (not | | | |
| following section 5.4.2 | on the connectors). | | | |
| High humidity test: | Storage at: 80° C., 96-100% RH, After 10 | Pass | Pass | Pass |
| Constant climate | hours, 14 V applied for 15 minutes | | | |
| following DIN EN ISO | (chamber 85° C.) then switched off, applied | | | |
| 6270-2-CH | again after 24 hours and repeated until the | | | |
| | end of the test. No mechanical load on | | | |
| | connectors, no voltage applied. 500 hours. | | | |
| Glass washing liquid | Immersion in washing liquid consisting of | Not | Not | Not |
| test | 69.5 vol % water | tested | tested | tested |
| | 20 vol % ethanol | | | |
| | 10 vol % isopropanol | | | |
| | 0.09 wt % sodium lauryl sulphate | | | |
| | 0.5 wt % ethylene glycol | | | |
| Salt Spray Test | 5% salt solution, 35° C. No voltage | Not | Not | Not |
| according to DIN EN | applied, no mechanical load applied. | tested | tested | tested |
| ISO 9227 (ISO 50021) | 96 hours | | | |

It can be seen from the results that the alternative Pb free solders also failed the test specification. The standard Pb containing solder passed the test specification.

Previous testing by the Applicant with Sn/Ag solders has always shown some failures in thermal cycle tests resulting in cracks or small blisters in theglass. Pb free solder 98% Sn 2% Ag has been tested extensively using laboratory samples and on products for vehicles and thermal cycle testing regularly causes cracks in the glass. When Sn/Ag/Cu solders have been tested the cracks in the glass are always worse. The Sn plating on conventional connectors melts during soldering and will expose the base copper underneath the plating. Copper is soluble in molten tin so some Cu from the connector could dissolve into the molten solder and change the properties of the Sn/Ag solder.

Using Ni plated connectors prevents the copper solubility and gives improved performance with SnAg solders, especially in a solder 98 wt % Sn, 2 wt % Ag.

Samples of glazing comprising a conductive component of silver containing ink, suitable for use as a bus bar, were soldered using solder of composition 98% Sn 2% Ag to connectors of either copper or brass, plated with either nickel or tin. Connector thickness was 0.8 mm. Samples were tested using a temperature cycling test. The maximum temperature in the cycling test was 80° C. and the minimum temperature was −30° C. One cycle consists of 30 minutes at 80° C. followed by 30 minutes at −30° C. with change between temperatures completed within 1 minute. The results are shown in Table 2.

TABLE 2

| | | | Samples | | |
|---|---|---|---|---|---|
| | | | with glass | Samples with glass | |
| Plating | Connector | Number of | crack after | crack after | Pass/ |
| material | material | samples | 100 cycles | 500 cycles | Fail |
| Sn | Cu | 22 | 1 | 4 | Fail |
| | Brass | 22 | 1 | 2 | Fail |
| Ni | Cu | 22 | 0 | 1 | Pass |
| | Brass | 22 | 1 | 2 | Fail |

The nickel-plated copper connector using 98% Sn 2% Ag was the only combination which passed the temperature cycle test after 100 cycles. Furthermore, this combination had the best performance after 500 cycles.

1. A glazing comprising at least one ply of glass having an electrically conductive component on at least one surface, and an electrical connector electrically connected to the electrically conductive component through a soldered joint, the solder of the joint having a composition comprising tin and silver, wherein the electrical connector comprises a nickel plated contact for contacting the solder.

2. A glazing as claimed in claim 1, wherein the solder has a composition comprising 0.45 wt % or less indium.

3. A glazing as claimed in claim 1, wherein the solder has a composition comprising less than 0.1 wt % Pb.

4. A glazing as claimed in claim 1, wherein the solder has a composition comprising 0.5 wt % or more silver.

5. A glazing as claimed in claim 1, wherein the solder has a composition comprising:
90 to 99.5 wt % Sn, and
1 to 10 wt % Ag.

6. A glazing as claimed in claim 1, wherein the solder has a composition comprising less than 5 wt % Cu, preferably less than 0.1 wt % Cu.

7. A glazing as claimed in claim 1, wherein the electrically conductive component comprises electrically conductive silver-containing ink.

8. A glazing according to claim 1, wherein the electrical connector comprises copper, preferably 99 to 99.99 wt % Cu.
